(19) United States
(12) Patent Application Publication
(10) Pub. No.: US 2022/0135052 A1
(43) Pub. Date: May 5, 2022

(54) MEASURING DRIVER SAFE-DRIVING QUOTIENTS

(71) Applicant: Harman International Industries, Incorporated, Stamford, CT (US)

(72) Inventors: Nikhil Patel, Prosper, TX (US); Prithvi Kambhampati, Dallas, TX (US); Greg Bohl, Muenster, TX (US); Sujal Shah, Troy, MI (US); Siva Subramanian, Sunnyvale, CA (US)

(21) Appl. No.: 17/452,713

(22) Filed: Oct. 28, 2021

Related U.S. Application Data
(60) Provisional application No. 63/108,111, filed on Oct. 30, 2020.

(51) Int. Cl. B60W 40/09; B60W 40/02; B60W 50/14; G06K 9/00

(52) U.S. Cl. CPC B60W 40/09; B60W 40/02; B60W 50/14; B60W 2040/0818; G06K 9/00597; G06K 9/00791; G06K 9/00845

(57) ABSTRACT

Mechanisms, methods, and systems are provided for establishing safe-driving quotients. Output of one or more sensors oriented toward an exterior of a vehicle (such as front-facing cameras) may be used to detect events. Output of one or more sensors oriented toward an interior of the vehicle (such as driver-facing cameras) may be captured, then analyzed to determine behavioral results corresponding with the events. Safe-driving quotients may then be established based on a ratio of the behavioral results to the events.

### CROSS REFERENCE TO RELATED APPLICATIONS

The present application claims priority to U.S. Provisional Application No. 63/108,111, entitled “MEASURING DRIVER SAFE-DRIVING QUOTIENTS,” and filed on October 30, 2020. The entire contents of the above-listed application are hereby incorporated by reference for all purposes.

### FIELD

The disclosure relates to Advanced Driver Assistance Systems for improving driving safety.

### BACKGROUND

Various Advanced Driver Assistance System (ADASes) have been developed to improve driving safety. Some systems may understand the world around the vehicle. Some systems may monitor a driver's behavior in order to evaluate the driver's state of mind. For example, some insurance companies may record driving data (e.g., from dongle-based devices). As another example, some systems may use a camera to capture safety-critical events and provide life-saving alerts. Virtual Personal Assistant (VPA) systems may allow a user (e.g., a driver) to connect via a phone or another device while driving in a vehicle. However, currently-available systems do not analyze both forward-facing camera (FFC) sensor devices and driver-facing camera (DFC) sensor devices to evaluate the safety and quality of a given driver's behavior, such as by differentiating between good driving behavior and bad driving behavior.

### SUMMARY

The methods, mechanisms, and systems disclosed herein may use externally-oriented sensor devices to detect various environmental conditions and events, and may use internally-oriented sensor devices to evaluate driving behavior in response to the environmental conditions and events. For example, the systems may determine whether a school zone speed limit is followed, whether right turns are avoided on red lights, whether yield signs and pedestrian crossings are observed, whether entry to and/or exit from a highway or freeway by following vehicles from other lane and speed, and so on.

The methods, mechanisms, and systems may then establish a driver's safe-driving quotient based on driver behavior and attentiveness during various driving situations. The driver's safe-driving quotient may characterize a driver's attention toward conditions and events in the environment surrounding a vehicle, and the driver's maneuvering of the vehicle with respect to those events. In this evaluation, poor driving behavior may be quantitatively penalized and good driving behavior may be quantitatively rewarded.

In some embodiments, the issues described above may be addressed by detecting events based on output of a first sensing device oriented toward an exterior of a vehicle (e.g., an FFC) and capturing an output of a second sensing device oriented toward an interior of the vehicle (e.g., a DFC). The output of the second sensing device may be analyzed to determine the occurrence, or lack of, behavioral results that correspond with the events, and a quotient may be established based on a ratio of the behavioral results to the events. In this way, both exterior-oriented sensing devices and interior-oriented sensing devices may be used to establish a safe-driving quotient that may advantageously facilitate safer driving.

For some embodiments, the issues described above may be addressed by detecting events based on output of a first camera configured to capture images from an exterior of a vehicle, and capturing output of a second camera configured to capture images from a driver region of the vehicle (e.g., a driver's seat), based upon the detection of the events. The output of the second camera may be analyzed to determine behavioral results corresponding with the events, based upon whether predetermined expected responses are determined to follow the events. A quotient based on a ratio of the behavioral results to the events may then be established, and the quotient may be provided (e.g., to a driver and/or passenger) via a display of the vehicle. In this way, by providing safe-driving quotients to drivers taking into account events outside the vehicle and behavioral responses to those events, driving safety may be improved.

In further embodiments, the issues described above may be addressed by two-camera systems for improving driving safety. The systems may detect events based on output of a first camera oriented toward an exterior of a vehicle, may capture output of a second camera oriented toward an interior of the vehicle, and may determine behavioral results corresponding with the events. In such systems, the capturing of the output of the second imaging device may be triggered based on the detection of the events, and the behavioral results may be determined based upon whether predetermined expected responses are determined to follow the events. The systems may then establish a quotient based on a ratio of those behavioral results to the events, which may then be provided a display of the vehicle.

In this way, by providing safe-driving quotients based on ratios of the occurrence of predetermined expected results to the events, driving safety may be improved.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The disclosure may be better understood from reading the following description of non-limiting embodiments, with reference to the attached drawings, wherein below:

FIG. 1 shows a functional diagram for a system for establishing safe-driving quotients for drivers of a vehicle, in accordance with one or more embodiments of the present disclosure;

FIG. 2 shows a diagram of an overall process flow applicable for a system for establishing safe-driving quotients for a vehicle, in accordance with one or more embodiments of the present disclosure; and

FIG. 3 shows an architecture of a system for establishing safe-driving quotients, in accordance with one or more embodiments of the present disclosure;

FIG. 4 shows applications for safe-driving quotients, in accordance with one or more embodiments of the present disclosure;

FIGS. 5 and 6 show flow charts of methods for establishing safe-driving quotients, in accordance with one or more embodiments of the present disclosure.

### DETAILED DESCRIPTION

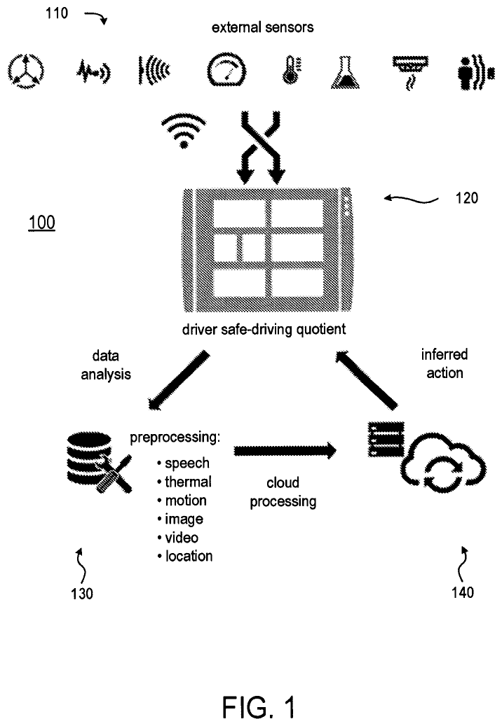

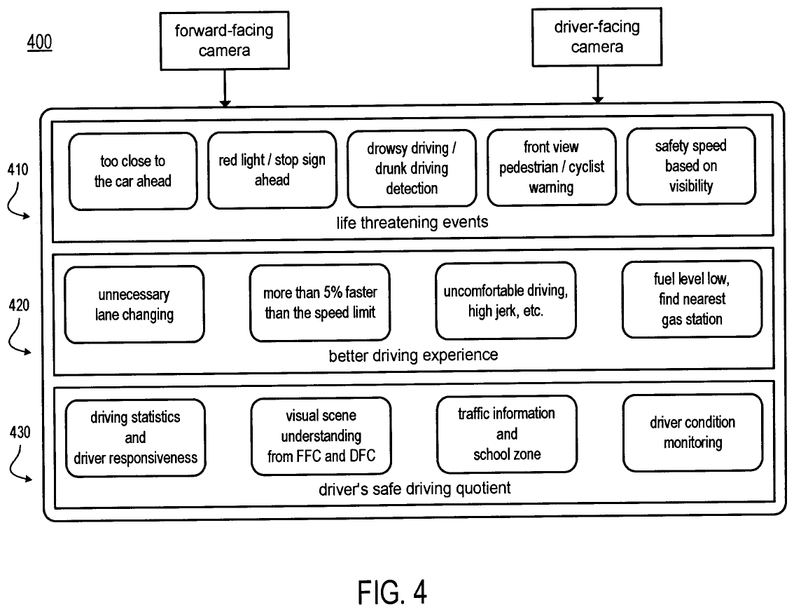

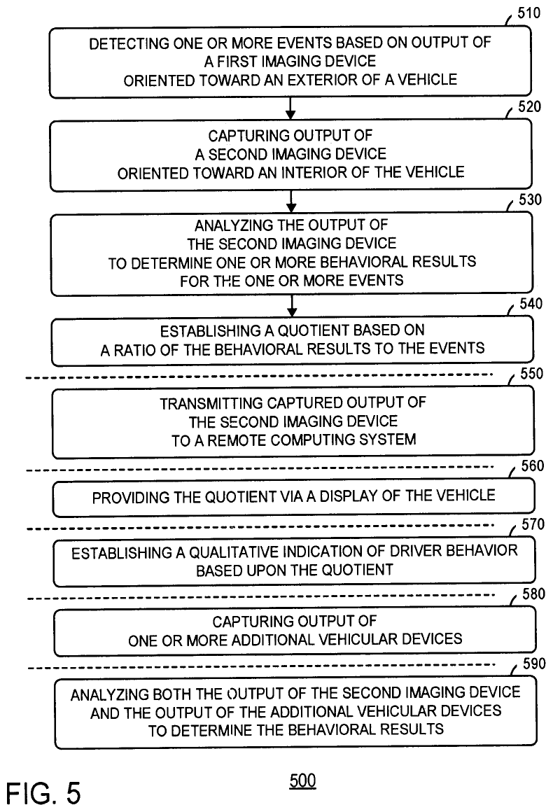

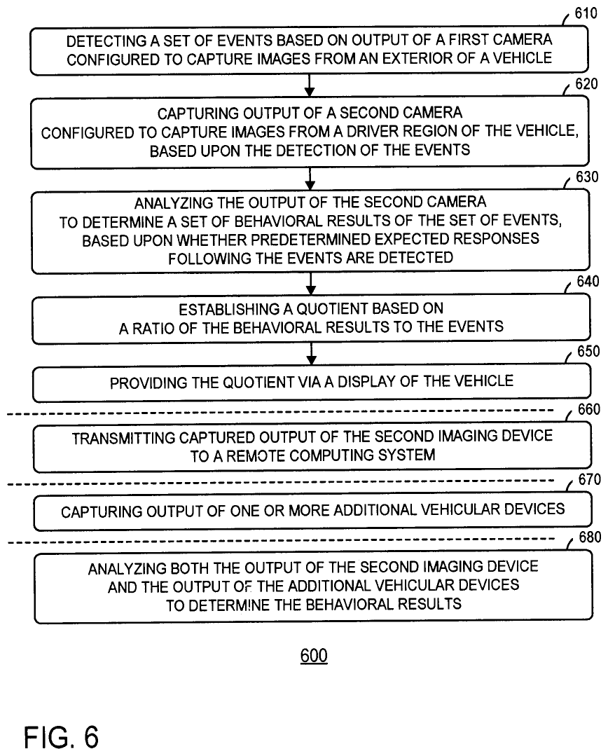

Disclosed herein are mechanisms, methods, and systems for establishing and using safe-driving quotients for drivers. FIGS. 1-3 provide a general view of such methods and systems, overall process flows employed by them, and various applications pertaining to them. FIG. 4 provides an example system architecture for some systems for establishing and using safe-driving quotients, and FIGS. 5 AND 6 provide example methods for establishing and using safe-driving quotients.

FIG. 1 shows a functional diagram for a system 100 for establishing safe-driving quotients for drivers of a vehicle. System 100 may comprise one or more first sensor devices 110, which may be externally-oriented and/or externally located. System 100 may also comprise one or more second sensor devices 120, which may be internally-oriented and/or internally-located.

In various embodiments, first sensor devices 110 and/or second sensor devices 120 may comprise one or more imaging devices. For example, first sensor devices 110 may comprise one or more FFCs, and second sensor devices 120 may comprise one or more DFCs. First sensor devices 110 and/or second sensor devices 120 may include one or more Original

Equipment Manufacturer (OEM) installed sensor devices. In some embodiments, first sensor devices 110 and/or second sensor devices 120 may comprise car-based digital video recorders (car DVRs), event data recorders (EDRs), and/or dashboard cameras (dashcams).

In some embodiments, system 100 may also combine data from one or more first sensor devices 110, one or more second sensor devices 120, and one or more other sensor devices and/or other sources, such as internal event data recorders (e.g., Head Unit devices, In-Vehicle Infotainment (IVI) devices, and Electronic Control Units (ECUs)), via vehicle busses and networks such as Controller Area Network busses (CAN busses). For some embodiments, system 100 may employ sensor fusion techniques utilizing various internal sensor devices and external sensor devices. For example, information from first sensor devices 110, second sensor devices 120, and/or other devices may be combined to provide a thorough understanding of a particular event or response behavior.

First sensor devices 110, which may comprise one or more FFCs (as discussed herein), may be located in the front of, to the back of, and/or to the sides of the vehicle. Some first sensor devices 110 may face a roadway external to a vehicle. For example, first sensor devices 110 may observe conditions in front of a vehicle. One or more of first sensor devices 110 (and/or other sensors) may continuously observe and/or monitor the environment surrounding the vehicle (e.g., what is in front of a driver), and events occurring outside the vehicle or conditions existing outside the vehicle may be detected based on output of first sensor devices 110.

Output of first sensor devices 110 may accordingly be used to detect various events which may have safety ramifications. Such events may comprise phenomena such as: violating a school zone speed limit; school zone pedestrian detection; violating a stop sign; exceeding a posted speed limit; taking an impermissible right turn on red traffic light; violating yield signs or pedestrian-crossing signs; improper entry to or exit from a freeway or highway (e.g., with respect to traffic in an adjacent lane, or with respect to a speed of the vehicle); time-to-collision events determined by the system due to a current speed (e.g., in the event of speeding); traffic light violations; lane departure warnings; a number of lane changes; a sudden braking; and/or following a car in an unsafe manner, based on traffic conditions.

In various embodiments, machine-learning based algorithms and techniques may be used to detect various events. For example, machine-learning based techniques may be used to detect traffic signs, lanes, and so on (e.g., based on output of one or more FFCs).

Second sensor devices 120, which may comprise one or more DFCs (as discussed herein), may be located within a cabin of the vehicle. Some second sensor devices 120 may be oriented to obtain data (e.g., video data) from a driver's area of the cabin, or may face a driver's area of the cabin. One or more of second sensor devices 120 may continuously observe and/or monitor the cabin of the vehicle (e.g., a driver), and output of one or more of second sensor devices 120 may be captured and analyzed to determine various behavioral results corresponding with the events. The behavioral results may represent a driver's reaction (or lack of reaction) to the events detected on the basis of the output of first sensor devices 110.

For example, second sensor devices 120 may freely record data, and upon detection of an event, the data may be captured for analysis. The captured data may be analyzed to determine behavioral results exhibited by a driver of the vehicle. The occurrence of behavioral results may then be determined based upon whether the detected events are followed by predetermined expected responses on the part of the driver (e.g., whether a driver responds in an expected manner to events that are detected).

Output of second sensor devices 120 may accordingly be used to determine whether a behavioral result occurs, which may pertain to a driver's state (e.g., state of mind) following the occurrence of an event. Such behavioral results may comprise phenomena such as: use of a cell phone (either speaking or texting) within a school zone; use of a cell phone (either speaking or talking) while a driven vehicle's speed exceeds a posted speed limit; a frequency or number of times driver distraction (e.g., eyes off the road) is detected (optionally more than a threshold, optionally accounting for roadway type); a detected drowsiness; a recognized emotion; a frequency or number of eye blinks (optionally more than a threshold, and/or optionally a function of eye aspect ratio); and/or a gaze directed toward an operational infotainment system.

Other devices (such as other sensor devices) may be used to identify various additional characteristics. Such characteristics may comprise phenomena such as: a time of day; a weather condition; a geographic location; a roadway type (e.g., highway, city, residential, and so on); a direction of incident sunlight toward a face of a driver; and/or a length of a drive.

In system 100, in a preprocessing unit 130, output of second sensor devices 120 (and/or other sensor devices) may be prepared for analysis to determine various behavioral results corresponding with the events. For some embodiments, in preprocessing unit 130, output of first sensor devices 110 may be prepared for analysis to detect an event. In some embodiments, preprocessing unit 130 may comprise one or more processors and one or more memory devices. For some embodiments, preprocessing unit 130 may comprise special-purpose or custom hardware. In various embodiments, preprocessing unit 130 may be local to the vehicle.

Preprocessing unit 130 may process image data and/or video data from second sensor devices 120. Preprocessing unit 130 may also process speech data, thermal data, motion data, location data, and/or other types of data from second sensor devices 120 (and/or other devices, such as other sensor devices). In some embodiments, preprocessing unit 130 may process image data and/or video date from first sensor devices 110.

In some embodiments, preprocessing unit 130 may be in wireless communication with a remote computing system 140. Once preprocessing unit 130 finishes its preparatory work, it may send a data package including the preprocessed data to remote computing system 140 (e.g., to the cloud), and remote computing system 140 may analyze the preprocessed data to determine various behavioral results corresponding with the events. (For some embodiments, the analysis of the data, along with any preprocessing of the data, may be local to the vehicle, and the determination of various behavioral results corresponding with the events may accordingly be performed by a local computing system.)

For various embodiments, preprocessing unit 130, remote computing system 140, and/or the local computing system may comprise custom-designed and/or configured electronic devices and/or circuitries operable to carry out parts of various methods disclosed herein. For various embodiments, preprocessing unit 130, remote computing system 140, and/or the local computing system may comprise one or more processors in addition to one or more memories having executable instructions that, when executed, cause the one or more processors to carry out parts of various methods disclosed herein. Preprocessing unit 130, remote computing system 140, and/or the local computing system may variously comprise any combination of custom-designed electronic devices and/or circuitries, processors, and memories as discussed herein.

In various embodiments, machine-learning based algorithms and techniques may be used (e.g., by remote computing system 140) to determine the occurrence of various behavioral results. For example, machine-learning based techniques may be used for face detection, object detection, gaze detection, head pose detection, lane detection, and so on (e.g., based on output of one or more DFCs). For some embodiments, machine-learning based algorithms and techniques may be used to determine the detection of various events (e.g., based on output of one or more FFCs).

For some embodiments, once remote computing system 140 has finished analyzing the preprocessed data, the determination of the occurrence of various behavioral results (and/or the detection of various events) may be communicated back to the vehicle. A local computing system of the vehicle may then establish (e.g., by computation) a safe-driving quotient based on a ratio of the behavioral results to the events. Moreover, in embodiments in which a local computing system is analyzing (and possibly pre-processing) the data, the local computing system may also establish the safe-driving quotient. In some embodiments, however, remote computing system 140 may establish the safe-driving quotient, and may communicate the quotient back to the vehicle.

In some embodiments, the safe-driving quotient may be a value between 0 and 1, and may indicate a ratio of a number of events for which predetermined expected response behaviors were observed to a total number of events (e.g., a fraction of events to which the driver reacted with appropriate expected behavior). In some embodiments, the various events comprising the ratio may be given various weights that may differ from each other. For various embodiments, the safe-driving quotient may be scaled or normalized and presented as a score representing an indication of driver performance. The safe-driving quotient (and/or resulting score) may also be mapped (e.g., in accordance with a predetermined mapping) to a qualitative indication of driver behavior (e.g., excellent, very good, good, fair, poor, or very poor). For example, in some embodiments, a score may be between 0 (which may correspond with very poor driving) and 100 (which may correspond with very good driving). In various embodiments, the safe-driving quotient may be any numerical value that is a function of both events detected as determined on the basis of outputs of first sensor devices 110, and behavioral results following the events as determined on the basis of the output of second sensor devices 120.

For various embodiments, system 100 may substantially continually establish and update a safe-driving quotient for a driver for the span of a trip in the vehicle. For various embodiments, instead of or in addition to being established for the span of a trip, a safe-driving quotient for a driver may be established over various other timespans. For example, safe-driving quotients may be established on a per-day basis, a per-week basis, and/or a per-month basis.

In various embodiments, the vehicle may have a display, and system 100 may be in communication with the display. Safe-driving quotients (and updates to safe-driving quotients) may then be provided via the display, for review by a driver and/or a passenger. System 100 may accordingly make drivers aware of how safe their driving may be. System 100 may also provide alerts in response to events on a roadway (e.g., by a computing system of a vehicle) which may present safety issues, and/or in response to safety-critical events.

Significant changes within a cabin of a vehicle may also be detected and reported to a driver.

System 100 may also advantageously be used to provide instantaneous alerts regarding detected events. Drivers may be notified, in a visual manner via the display and/or in an audio manner (e.g., via an audio system of the vehicle), of dangerous or unusual circumstances.

The feedback provided by safe-driving quotients may advantageously provide guidance for better driver safety, and may advantageously help a driver improve their ability to react quickly to events detected by system 100. Safe-driving quotients may also improve driving experiences in various other ways, such as by improving fuel economy, and potentially impacting insurance premiums (e.g., if enrolled with an insurance provider for usage-based insurance programs). In some embodiments, safe-driving quotients of new drivers (or other drivers in training) may be advantageously monitored by parents or other instructors (e.g., in person, or via remote update), in order to help coach the new drivers and improve their driving safety.

Various machine-learning models (e.g., convolutional neural-net models) may be available at a local computing system of the vehicle, and/or in cloud 140, for use by system 100. The models may be used to detect events and/or determine behavioral results. In this way, system 100 may detect, classify, and extract various features through algorithms of machine-learning models. In various embodiments, the models may be pre-trained.

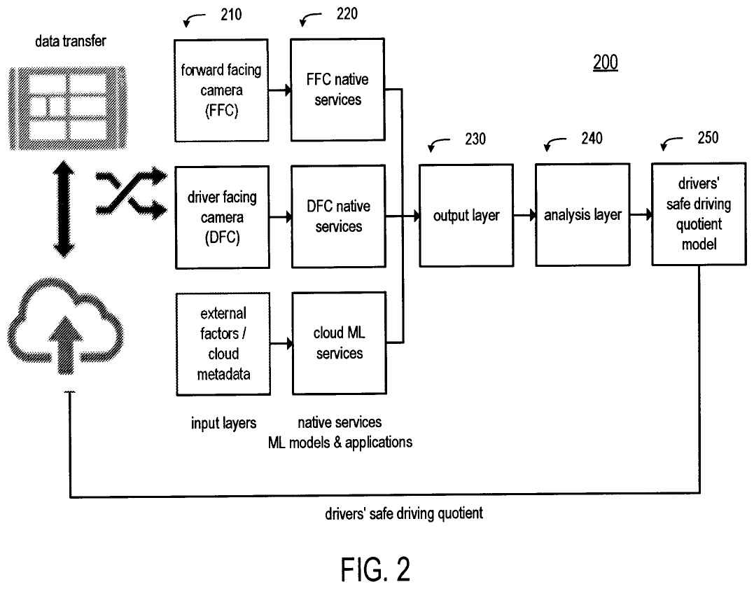

FIG. 2 shows a diagram of an overall process flow 200 applicable for a system for establishing safe-driving quotients for a vehicle, such as system 100. Process flow 200 may comprise input layers 210, services 220, output layer 230, analysis layer 240, and quotient model 250.

In input layers 210, data coming from one or more FFCs, one or more DFCs, and external factors (such as other devices or sensor devices, and/or cloud metadata) may be provided to process flow 200. The FFCs may include devices substantially similar to first sensor devices 110, and the DFCs may include devices substantially similar to second sensor devices 120. Data from input layers 210 may then flow to corresponding portions of services 220, which may include preprocessing of the data from input layers 210.

After application of native services corresponding with the input layers, services 220 may then supply data to output layer 230, which may provide data to analysis layer 240 (e.g., to be analyzed), which may provide analyzed data and/or other results of the data analysis to quotient model 250. From there, quotient model 250 may produce a safe-driving quotient.

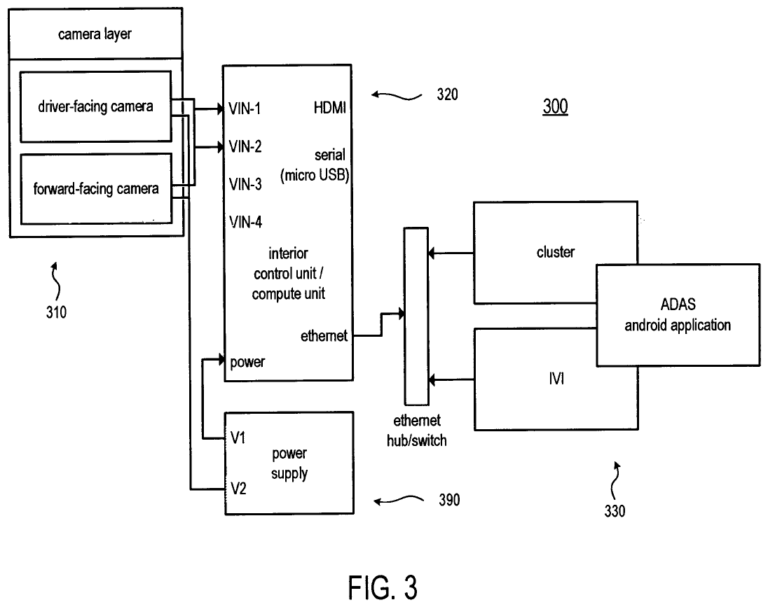

FIG. 3 shows an architecture 300 of a system for establishing safe-driving quotients, which may be substantially similar to system 100. Architecture 300 may comprise a camera layer 310, a local computing unit 320, and various additional devices 330. A power supply 390 may supply electrical power to cameral layer 310, local computing unit 320, and additional devices 330.

Cameral layer 310 may in turn include one or more FFCs (which may be substantially similar to first sensor devices 110) and one or more DFCs (which may be substantially similar to second sensor devices 120). A video output from the FFCs and/or a video output from the DFCs may be provided to local computing unit 320 (which may comprise a local computing system of a vehicle, such as discussed herein), which may provide functionality similar to preprocessing unit 130. Local computing unit 320 may then be communicatively coupled to additional devices 330 (which may include clusters of one or more devices such as ECUs and/or IVIs), e.g., through a network or vehicle bus.

FIG. 4 shows applications 400 for safe-driving quotients. Some applications may advantageously make driving experiences safer, smoother, and more event-free, and help a driver make proper decisions at critical moments (and possibly thereby avoid accidents). Some embodiments may advantageously make a vehicle's cabin more enjoyable and safe while enhancing a user experience. Various embodiments may advantageously help a driver focus on a roadway, reducing occasions to check panels and indicators in front. Some applications may advantageously employ facial recognition, emotion recognition (using facial recognition), recommender systems (e.g., for music, lighting, and so on) based on passenger profiles, determinations of location and road type from a cloud-based database, detection of other passengers in the back (such as small children), and detection of changes to the front of the vehicle's cabin (e.g., driver and/or passenger changes), in order to associate drivers with safe-driving quotients).

The methods, mechanisms, and systems disclosed herein may utilize sensor devices such as FFCs and DFCs to inform a driver of the detection of various types of events. A first set of applications 410 may relate to life-threatening events. A second set of applications 420 may relate to potential improvements in driving experiences. A third set of applications 430 may relate to a driver's safe-driving quotient.

The first set of applications 410 may include various applications. For applications 410, forward-looking cameras (e.g., FFCs), in-cabin cameras (e.g., DFCs) and telematics data may be evaluated in combination to determine whether a stop sign or red light has been ignored. In-cabin cameras (e.g., DFCs) and a lane-detection module may be used to determine occurrences of drowsy driving or drunk driving. FFCs may be evaluated to determine occurrences pedestrians and/or cyclists in front of the vehicle. On-board cameras (e.g., FFCs and/or DFCs) may be used to determine a poor-visibility weather condition. In various embodiments, applications 410 may determine whether a car ahead is too close, whether there is a red light and/or a stop sign ahead, whether a drowsy-driving and/or drunk-diving scenario is detected, whether a pedestrian and/or cyclist is ahead, whether a speed of the vehicle is safe (e.g., based on a current visibility), and so forth.

The second set of applications 420 may include various applications. For applications 420, sensor devices (e.g., FFCs and/or DFCs) may be used to determine occurrences of too-frequent lane changes, occurrences of cars in front of the vehicle that suddenly decrease speed or stop, the presence of emergency vehicles nearby (and, optionally, direction and distance), a vehicle speed that exceeds a relevant speed limit by a threshold amount or percentage, a high rate of jerk which may lead to an uncomfortable driving experience, and a low fuel level while a gas station is detected nearby. In various embodiments, applications 420 may determine whether a lane change is unnecessary, whether a speed limit is being exceeded by more than a predetermined percentage or amount (e.g., by more than 5%), whether a period of driving is uncomfortable (e.g., by having a high jerk or other acceleration-related characteristic), whether a fuel level is low, and so forth.

The third set of applications 430 may include various applications. For applications 430, safe-driving quotients may be used to maintain driver statistics and/or improve driver responsiveness. Safe-driving quotients may also relate to understandings of a visual scene as obtained from FFCs and/or DFCs. Safe-driving quotients may also relate to traffic information and school zones. Safe-driving quotients may also relate to driver condition monitoring.

FIG. 5 shows a flow chart of a method 500 for establishing safe-driving quotients. Method 500 may comprise a first part 510, a second part 520, a third part 530, and a fourth part 540. In various embodiments, method 500 may also comprise a fifth part 550, a sixth part 560, a seventh part 570, an eighth part 580, and/or a ninth part 590.

In first part 510, one or more events may be detected based on output of a first imaging device oriented toward an exterior of a vehicle (such as an event detected by a first sensor device 110, as discussed herein). In second part 520, output of a second imaging device oriented toward an interior of the vehicle may be captured (such as output captured from a second sensor device 120, as discussed herein). In third part 530, the output of the second imaging device may be analyzed to determine one or more behavioral results respectively corresponding with the one or more events such as by a preprocessing unit 130, as discussed herein). In fourth part 540, a quotient based on a ratio of the behavioral results to the events may be established (such as by a local computing system of a vehicle, as discussed herein, for example in response to data analysis performed by a remote computing system 140).

In some embodiments, the capturing of the output of the second imaging device may be triggered based on the detection of the events. For some embodiments, the behavioral results may be determined based upon whether predetermined expected responses following the events are detected. In some embodiments, the events may include detection of a speed limit indication, a stop sign, a traffic light state, a no-right-turn-on-red-light indication, a yield indication, a braking rate, a roadway entry indication, a roadway exit indication, a lane departure, a number of lanes changed, an estimated time-to-collision, a school zone speed indication, and/or a school zone pedestrian indication. For some embodiments, the behavioral results may include indication of drowsiness, a number of times or frequency of driver eyes being diverted from a roadway-oriented gaze, a number of times or frequency of driver attention directed to an infotainment system, a number of times or frequency of driver eyes blinking, a predetermined emotion, use of a cell phone, use of a cell phone beyond a predetermined speed, and/or use of a cell phone within a school zone.

In various embodiments, in fifth part 550, captured output of the second imaging device may be transmitted to a remote computing system (such as remote computing system 140, as discussed herein). For some embodiments, an analysis of the transmitted output of the second imaging device may be done by the remote computing system.

For various embodiments, in sixth part 560, the quotient may be provided via a display of the vehicle, or in another audio and/or video manner. In various embodiments, in seventh part 570, a qualitative indication of driver behavior (e.g., excellent, very good, good, fair, poor, or very poor) may be established based upon the quotient. For various embodiments, in eighth part 580, output of one or more additional vehicular devices (such as one or more ECUs, IVIs, and/or other additional device 330 disclosed herein) may be captured. In various embodiments, in ninth part 590, both the output of the second imaging device and the output of the additional vehicular devices may be analyzed to determine the behavioral results. For some embodiments, the output of the additional vehicular devices may include indication of a time of day, a weather condition, a geographic location, a type of roadway, a direction of sunshine incident to a driver's face, and/or a transpired length of a drive.

For some embodiments, the first imaging device may be a dashboard camera. In some embodiments, the first imaging device may be a forward-facing camera, and the second imaging device may be a driver-facing camera.

FIG. 6 shows a flow chart of a method 600 for establishing safe-driving quotients. Method 600 may comprise a first part 610, a second part 620, a third part 630, a fourth part 640, and a fifth part 650. In various embodiments, method 600 may also comprise a sixth part 660, a seventh part 670, and/or an eighth part 680.

In first part 610, a set of events may be detected based on output of a first camera configured to capture images from an exterior of a vehicle (such as a set of one or more events detected by a first sensor device 110, as discussed herein). In second part 620, output of a second camera configured to capture images from a driver region of the vehicle (such as output of a second sensor device 120, as discussed herein) may be captured, based upon the detection of the events. In third part 630, the output of the second camera may be analyzed (such as by a remote computing system 140, as discussed herein) to determine a set of behavioral results respectively corresponding with the set of events, based upon whether predetermined expected responses following the events are detected. In fourth part 640, a quotient may be established based on a ratio of the behavioral results to the events (such as by a local computing system of a vehicle, as discussed herein, for example in response to data analysis performed by a remote computing system 140). In fifth part 650, the quotient may be provided via a display of the vehicle, or in another audio and/or video manner.

In some embodiments, the events may include detection of a speed limit indication, a stop sign, a traffic light state, a no-right-turn-on-red-light indication, a yield indication, a braking rate, a roadway entry indication, a roadway exit indication, a lane departure, a number of lanes changed, an estimated time-to-collision, a school zone speed indication, and/or a school zone pedestrian indication. For some embodiments, the behavioral results may include indication of drowsiness, a number of times or frequency of driver eyes being diverted from a roadway-oriented gaze, a number of times or frequency of driver attention directed to an infotainment system, a number of times or frequency of driver eyes blinking, a predetermined emotion, use of a cell phone, use of a cell phone beyond a predetermined speed, and/or use of a cell phone within a school zone.

In various embodiments, in sixth part 660, captured output of the second imaging device may be transmitted to a remote computing system (such as remote computing system 140, as discussed herein). In some embodiments, an analysis of the transmitted output of the second imaging device may be done by the remote computing system. For various embodiments, in seventh part 670, output of one or more additional vehicular devices (such as one or more ECUs, IVIs, and/or other additional device 330 disclosed herein) may be captured. In various embodiments, in eighth part 680, both the output of the second imaging device and the output of the additional vehicular devices may be analyzed to determine the behavioral results. For some embodiments, the output of the additional vehicular devices may include indication of a time of day, a weather condition, a geographic location, a type of roadway, a direction of sunshine incident to a driver's face, and a transpired length of a drive.

In various embodiments, parts of method 500 and/or method 600 may be carried out by a circuitry comprising custom-designed and/or configured electronic devices and/or circuitries. For various embodiments, parts of method 500 and/or method 600 may be carried out by a circuitry comprising one or more processors and one or more memories having executable instructions for carrying out the parts, when executed. Parts of method 500 and/or method 600 may variously be carried out by any combination of circuitries comprising custom-designed and/or configured electronic devices and/or circuitries, processors, and memories as discussed herein.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices, such as the systems described above with respect to FIGS. 1-4. The methods may be performed by executing stored instructions with one or more logic devices (e.g., processors) in combination with one or more additional hardware elements, such as storage devices, memory, image sensors/lens systems, light sensors, hardware network interfaces/antennas, switches, actuators, clock circuits, and so on. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

In a first approach to the methods and systems discussed herein, a first example of a method comprises: detecting one or more events based on output of a first imaging device oriented toward an exterior of a vehicle; capturing output of a second imaging device oriented toward an interior of the vehicle; analyzing the output of the second imaging device to determine one or more behavioral results respectively corresponding with the one or more events; and establishing a quotient based on a ratio of the behavioral results to the events. In a second example building off of the first example, the capturing of the output of the second imaging device is triggered based on the detection of the events. In a third example building off of either the first example or the second example, the behavioral results are determined based upon whether predetermined expected responses following the events are detected. In a fourth example building off of any of the first example through the third example, the events include detection of one or more of: a speed limit indication; a stop sign; a traffic light state; a no-right-turn-on-red-light indication; a yield indication; a braking rate; a roadway entry indication; a roadway exit indication; a lane departure; a number of lanes changed; an estimated time-to-collision; a school zone speed indication; and a school zone pedestrian indication. In a fifth example building off of any of the first example through the fourth example, the behavioral results include indication of one or more of: drowsiness; a number of times or frequency of driver eyes being diverted from a roadway-oriented gaze; a number of times or frequency of driver attention directed to an infotainment system; a number of times or frequency of driver eyes blinking; a predetermined emotion; use of a cell phone; use of a cell phone beyond a predetermined speed; and use of a cell phone within a school zone. In a sixth example building off of any of the first example through the fifth example, the method further comprises: transmitting captured output of the second imaging device to a remote computing system. In a seventh example building off of the sixth example, the analysis of the transmitted output of the second imaging device is done by the remote computing system. In an eighth example building off of any of the first example through the seventh example, the method further comprises: providing the quotient via a display of the vehicle. In a ninth example building off of any of the first example through the eighth example, the method further comprises: establishing a qualitative indication of driver behavior based upon the quotient. In a tenth example building off of any of the first example through the ninth example, the method further comprises: capturing output of one or more additional vehicular devices; and analyzing both the output of the second imaging device and the output of the additional vehicular devices to determine the behavioral results. In an eleventh example building off of the tenth example, the output of the additional vehicular devices includes indication of one or more of: a time of day; a weather condition; a geographic location; a type of roadway; a direction of sunshine incident to a driver's face; and a transpired length of a drive. In a twelfth example building off of any of the first example through the eleventh example, the first imaging device is a dashboard camera. In a thirteenth example building off of any of the first example through the twelfth example, the first imaging device is a forward-facing camera; and the second imaging device is a driver-facing camera.

In a second approach to the methods and systems discussed herein, a first example of a method of improving driving safety comprises: detecting a set of events based on output of a first camera configured to capture images from an exterior of a vehicle;

capturing output of a second camera configured to capture images from a driver region of the vehicle, based upon the detection of the events; analyzing the output of the second camera to determine a set of behavioral results respectively corresponding with the set of events, based upon whether predetermined expected responses following the events are detected; establishing a quotient based on a ratio of the behavioral results to the events; and providing the quotient via a display of the vehicle. In a second example building off of the first example, the events include detection of one or more of: a speed limit indication; a stop sign; a traffic light state; a no-right-turn-on-red-light indication; a yield indication; a braking rate; a roadway entry indication; a roadway exit indication; a lane departure; a number of lanes changed; an estimated time-to-collision; a school zone speed indication; and a school zone pedestrian indication; and the behavioral results include indication of one or more of:

drowsiness; a number of times or frequency of driver eyes being diverted from a roadway-oriented gaze; a number of times or frequency of driver attention directed to an infotainment system; a number of times or frequency of driver eyes blinking; a predetermined emotion; use of a cell phone; use of a cell phone beyond a predetermined speed; and use of a cell phone within a school zone. In a third example building off of either the first example or the second example, the method further comprises: transmitting captured output of the second imaging device to a remote computing system, and the analysis of the transmitted output of the second imaging device is done by the remote computing system. In a fourth example building off of any of the first example through the third example, the method further comprises: capturing output of one or more additional vehicular devices; and analyzing both the output of the second imaging device and the output of the additional vehicular devices to determine the behavioral results, and the output of the additional vehicular devices includes indication of one or more of: a time of day; a weather condition; a geographic location; a type of roadway; a direction of sunshine incident to a driver's face; and a transpired length of a drive.

In a third approach to the methods and systems discussed herein, a first example of a two-camera system for improving driving safety, comprises: one or more processors; and a memory storing instructions that, when executed, cause the one or more processors to: detect one or more events based on output of a first camera oriented toward an exterior of a vehicle; capture output of a second camera oriented toward an interior of the vehicle; determine one or more behavioral results corresponding with the one or more events;

establish a quotient based on a ratio of those behavioral results to the events; and provide the quotient via a display of the vehicle, wherein the capturing of the output of the second imaging device is triggered based on the detection of the events; and wherein the behavioral results are determined based upon whether predetermined expected responses following the events are detected. In a second example building off of the first example, the events include detection of one or more of: a speed limit indication; a stop sign; a traffic light state; a no-right-turn-on-red-light indication; a yield indication; a braking rate; a roadway entry indication; a roadway exit indication; a lane departure; a number of lanes changed; an estimated time-to-collision; a school zone speed indication; and a school zone pedestrian indication; and the behavioral results include indication of one or more of: drowsiness; a number of times or frequency of driver eyes being diverted from a roadway-oriented gaze; a number of times or frequency of driver attention directed to an infotainment system; a number of times or frequency of driver eyes blinking; a predetermined emotion; use of a cell phone; use of a cell phone beyond a predetermined speed; and use of a cell phone within a school zone. In a third example building off of either the first example or the second example, the instructions, when executed, further cause the one or more processors to: transmit captured output of the second imaging device to a remote computing system, and the determination that behavioral results correspond with the events and the establishment of the quotient is done by the remote computing system.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. Terms such as “first,” “second,” “third,” and so on are used merely as labels, and are not intended to impose numerical requirements or a particular positional order on their objects. The following claims particularly point out subject matter from the above disclosure that is regarded as novel and non-obvious.

1. A method comprising:
detecting one or more events based on output of a first imaging device oriented toward an exterior of a vehicle;
capturing output of a second imaging device oriented toward an interior of the vehicle;
analyzing the output of the second imaging device to determine one or more behavioral results respectively corresponding with the one or more events; and
establishing a quotient based on a ratio of the behavioral results to the events.

2. The method of claim 1,
wherein the capturing of the output of the second imaging device is triggered based on the detection of the events.

3. The method of claim 1,
wherein the behavioral results are determined based upon whether predetermined expected responses following the events are detected.

4. The method of claim 1,
wherein the events include detection of one or more of: a speed limit indication; a stop sign; a traffic light state; a no-right-turn-on-red-light indication; a yield indication; a braking rate; a roadway entry indication; a roadway exit indication; a lane departure; a number of lanes changed; an estimated time-to-collision; a school zone speed indication; and a school zone pedestrian indication.

5. The method of claim 1,
wherein the behavioral results include indication of one or more of: drowsiness; a number of times or frequency of driver eyes being diverted from a roadway-oriented gaze; a number of times or frequency of driver attention directed to an infotainment system; a number of times or frequency of driver eyes blinking; a predetermined emotion; use of a cell phone; use of a cell phone beyond a predetermined speed; and use of a cell phone within a school zone.

6. The method of claim 1, further comprising:
transmitting captured output of the second imaging device to a remote computing system.

7. The method of claim 6,
wherein the analysis of the transmitted output of the second imaging device is done by the remote computing system.

8. The method of claim 1, further comprising:
providing the quotient via a display of the vehicle.

9. The method of claim 1, further comprising:
establishing a qualitative indication of driver behavior based upon the quotient.

10. The method of claim 1, further comprising:
capturing output of one or more additional vehicular devices; and
analyzing both the output of the second imaging device and the output of the additional vehicular devices to determine the behavioral results.

11. The method of claim 10,
wherein the output of the additional vehicular devices includes indication of one or more of: a time of day; a weather condition; a geographic location; a type of roadway; a direction of sunshine incident to a driver's face; and a transpired length of a drive.

12. The method of claim 1,
wherein the first imaging device is a dashboard camera.

13. The method of claim 1,
wherein the first imaging device is a forward-facing camera; and
wherein the second imaging device is a driver-facing camera.

14. A method of improving driving safety, the method comprising:
detecting a set of events based on output of a first camera configured to capture images from an exterior of a vehicle;
capturing output of a second camera configured to capture images from a driver region of the vehicle, based upon the detection of the events;
analyzing the output of the second camera to determine a set of behavioral results respectively corresponding with the set of events, based upon whether predetermined expected responses following the events are detected;
establishing a quotient based on a ratio of the behavioral results to the events; and
providing the quotient via a display of the vehicle.

15. The method of claim 14,
wherein the events include detection of one or more of: a speed limit indication; a stop sign; a traffic light state; a no-right-turn-on-red-light indication; a yield indication; a braking rate; a roadway entry indication; a roadway exit indication; a lane departure; a number of lanes changed; an estimated time-to-collision; a school zone speed indication; and a school zone pedestrian indication; and
wherein the behavioral results include indication of one or more of: drowsiness; a number of times or frequency of driver eyes being diverted from a roadway-oriented gaze; a number of times or frequency of driver attention directed to an infotainment system; a number of times or frequency of driver eyes blinking; a predetermined emotion; use of a cell phone; use of a cell phone beyond a predetermined speed; and use of a cell phone within a school zone.

16. The method of claim 14, further comprising:
transmitting captured output of the second imaging device to a remote computing system,
wherein the analysis of the transmitted output of the second imaging device is done by the remote computing system.

17. The method of claim 14, further comprising:
capturing output of one or more additional vehicular devices; and
analyzing both the output of the second imaging device and the output of the additional vehicular devices to determine the behavioral results,
wherein the output of the additional vehicular devices includes indication of one or more of: a time of day; a weather condition; a geographic location; a type of roadway; a direction of sunshine incident to a driver's face; and a transpired length of a drive.

18. A two-camera system for improving driving safety, comprising:
one or more processors; and
a memory storing instructions that, when executed, cause the one or more processors to:
detect one or more events based on output of a first camera oriented toward an exterior of a vehicle;
capture output of a second camera oriented toward an interior of the vehicle;
determine one or more behavioral results corresponding with the one or more events;
establish a quotient based on a ratio of those behavioral results to the events; and
provide the quotient via a display of the vehicle,
wherein the capturing of the output of the second imaging device is triggered based on the detection of the events; and
wherein the behavioral results are determined based upon whether predetermined expected responses following the events are detected.

19. The two-camera system of claim 18,
wherein the events include detection of one or more of: a speed limit indication; a stop sign; a traffic light state; a no-right-turn-on-red-light indication; a yield indication; a braking rate; a roadway entry indication; a roadway exit indication; a lane departure; a number of lanes changed; an estimated time-to-collision; a school zone speed indication; and a school zone pedestrian indication; and
wherein the behavioral results include indication of one or more of: drowsiness; a number of times or frequency of driver eyes being diverted from a roadway-oriented gaze; a number of times or frequency of driver attention directed to an infotainment system; a number of times or frequency of driver eyes blinking; a predetermined emotion; use of a cell phone; use of a cell phone beyond a predetermined speed; and use of a cell phone within a school zone.

20. The two-camera system of claim 18, wherein the instructions, when executed, further cause the one or more processors to:
transmit captured output of the second imaging device to a remote computing system,
wherein the determination that behavioral results correspond with the events and the establishment of the quotient is done by the remote computing system.
